(19) United States
(12) Patent Application Publication
(10) Pub. No.: US 2018/0012262 A1
(43) Pub. Date: Jan. 11, 2018

(54) COMPUTER IMPLEMENTED METHODS AND SYSTEM FOR TRADING KEYWORD(S) AND MANAGING REVENUE IN A SEARCH NETWORK

(71) Applicants: RASHMIT GUPTA, Hyderabad (IN); VISHAL GUPTA, Mumbai (IN)

(72) Inventors: RASHMIT GUPTA, Hyderabad (IN); VISHAL GUPTA, Mumbai (IN)

(21) Appl. No.: 15/545,318

(22) PCT Filed: Sep. 15, 2015
(86) PCT No.: PCT/IB2015/057082

§ 371 Date: Jul. 21, 2017

(30) Foreign Application Priority Data
Mar. 12, 2015 (IN) 1236/CHE/2015

(51) Int. Cl. G06Q 30/02; G06F 17/30

(52) U.S. Cl. CPC G06Q 30/0273; G06Q 30/0256; G06F 17/30864; G06Q 30/0202

(57) ABSTRACT

Exemplary embodiments of the present disclosure are directed towards a computer implemented method comprising enabling a user to search for at least one keyword available for buying by inputting the at least one keyword. The method includes displaying the at least one keyword available for buying in response to the user inputting the at least one keyword, whereby the at least one keyword available for buying associated with at least one of: pricing raging from a minimum value to a maximum value or a fixed pricing and selecting the at least one keyword available for buying. The method also includes initiating an online payment for buying the at least one keyword.

### TECHNICAL FIELD

The present disclosure relates to the field of revenue driven models in search networks. More particularly, the present disclosure relates to computer implemented methods and system for keyword(s) trading and managing revenue in a search network.

### BACKGROUND

The statements in this section merely provide background information related to the present disclosure and may not constitute prior art.

Typically keywords are used in search engine to obtain the intended search results. Many of the search service providers have created paid inclusion or paid placement programs to obtain broader reach for more targeted advertising audiences. By identifying the keywords that the target audience is using to find information or products related to a business, a monetized search box is provided, that earn a fee or a commission for search service providers each time the user conducts a search.

For example, a user conducts search for “HOTELS IN BOMBAY”, in response the intended search results are displayed. For providing the targeted search results to the user the hotels in Bombay pay to search service providers to display their advertisements. In return the search service providers earn revenues by displaying the targeted search results. These advertising strategies implemented by the search service providers create huge revenue to the search service providers and the users are not benefited. Moreover, the search service providers fail to convert the keywords in to digital assets.

In the light of aforementioned discussion there exists need for a system and method that would ameliorate and overcome the abovementioned disadvantages.

### BRIEF SUMMARY

The following presents a simplified summary of the disclosure in order to provide a basic understanding to the reader. This summary is not an extensive overview of the disclosure and it does not identify key/critical elements of the disclosure or delineate the scope of the disclosure. Its sole purpose is to present some concepts disclosed herein in a simplified form as a prelude to the more detailed description that is presented later.

Exemplary embodiments of the present disclosure are directed towards a computer implemented methods and system for trading keyword(s) and hashtag(s) and managing revenue in a search network.

An exemplary objective of the present disclosure it to provide a search network for enabling the user to earn assets by trading the keywords.

Another exemplary objective of the present disclosure is to convert the keyword(s) and hashtag(s) used in the search network to assets.

Another exemplary objective of the present disclosure is to dynamically track the value of keyword(s) and hashtag(s) and invest the assets earned for buying additional keyword(s) and hashtag(s).

Another exemplary objective of the present disclosure is to dynamically forecast the value of the keyword(s) based on the search trends associated with the keyword(s) hashtag(s).

Another exemplary objective of the present disclosure is to enable the user to use analytics tool to see and forecast the search trends associated with the keyword(s) and hashtag(s).

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF DRAWINGS

The drawings described herein are for illustration purposes only and are not intended to limit the scope of the present disclosure in anyway. Throughout the disclosure, like elements are represented by like reference numerals, which are given by way of illustration only and thus are not limitative of the various embodiments.

FIG. 1 is a diagram depicting a search network, according to an exemplary embodiment of the present disclosure.

FIG. 2 is a block diagram of the system for trading keyword(s) and managing revenue in a search network, according to an exemplary embodiment of the present disclosure.

FIG. 3 is a diagram depicting the system of FIG. 1 and FIG. 2, according to an exemplary embodiment of the present disclosure

FIG. 4 is a use case diagram of a system for trading keyword(s) and managing revenue, according to an exemplary embodiment of the present disclosure.

FIG. 5 is a flow diagram depicting a method for buying keyword(s), according to an exemplary embodiment of the present disclosure.

FIG. 6 is flow diagram depicting the method for earning assets by the user, according to an exemplary embodiment of the present disclosure.

FIG. 7 is flow diagram depicting the method for earning assets by the user and the owner, according to an exemplary embodiment of the present disclosure.

Other objects and advantages of the present disclosure will become apparent to those skilled in the art upon reading the following detailed description of the preferred embodiments, in conjunction with the accompanying drawings, wherein:

### BRIEF DESCRIPTION OF EXEMPLARY EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item.

According to a non-limiting exemplary embodiment of the present disclosure, a computer implemented method and system for trading keyword and managing revenue in a search network are disclosed.

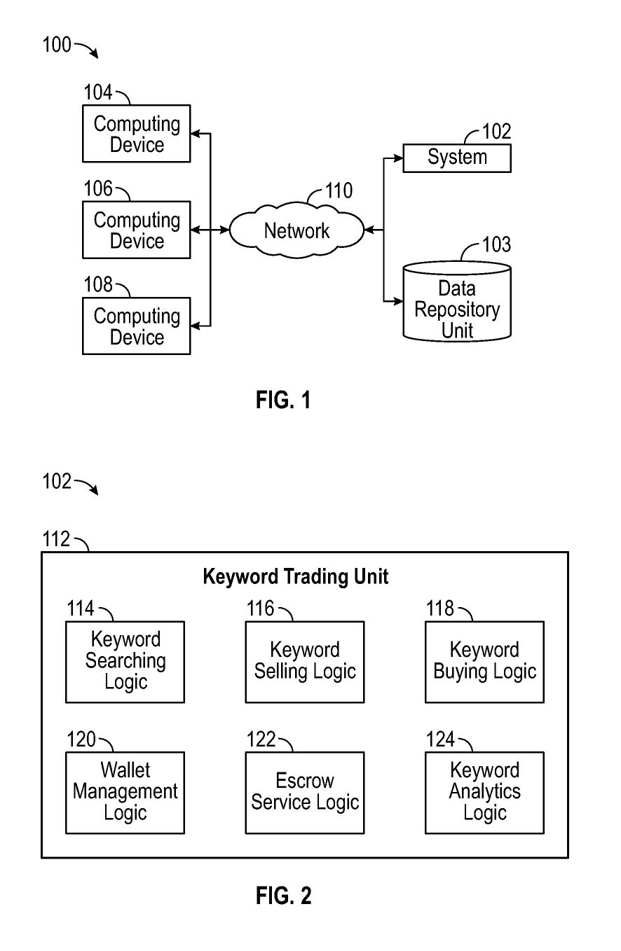

Referring to FIG. 1 is a diagram 100 depicting a search network, according to an exemplary embodiment of the present disclosure. The search network includes a system for trading keyword(s), herein after referred as system 102. The system 102 may also be used for trading hashtags. The search network also allows the user to trade keyword(s) in a data repository unit 103 connected to the system 102. The search network 100 is a network of computing devices 104, 106 and 108 and system 102 in which the present invention may be implemented. The computing devices 104, 106 and 108 and system 102 are all connected over a network 110. The network 108 may include, but not limited to, an Ethernet, a local area network (LAN), or a wide area network (WAN), e.g., the Internet, or a combination of networks.

The system 102 allows the user to trade keyword(s) in the search network. Trading keyword(s) in the search network may include but not limited to buying the keyword, selling the keyword. The keyword(s) here may include but not limited to any alphabet(s), word(s), special character(s), numeral(s), and alphanumeric character(s) and the combination of alphabet(s), word(s), special character(s), numeral(s), and alphanumeric character(s). The system 102 allows the user to buy the keyword(s) in the search network. Furthermore the system allows the user to input keyword(s) for retrieving the desired results. In response to the user using the keyword(s) of the owner, the system 102 dynamically credits assets to the account of the owner of the keyword. Also, the system 102 dynamically credits assets to the account of the user conducting the search in response to conducting the search in the search network. The assets here may include, but not limited, to Bitcoin, loyalty points, rewards, digital currency, vouchers, reward points, coupons, and cash. The assets earned by the user may be used for buying the keywords. For example, for each search made by the user using the keyword, the owner of the keyword earns predetermined value of assets. Considering the assets as a bitcoin, for instance if the keyword(s) owned by the user are used in the search network for 100 times, the keyword owner earns 10000 satoshis, where the profit percentage of the keyword owner is 25%. According to an exemplary embodiment of the present disclosure, the transactions associated with the keyword(s) trading may be recorded in a public distributed ledger called the block chain.

Referring to FIG. 2 is a block diagram 102 of the system for trading keywords in a search network, according to an exemplary embodiment of the present disclosure. The system 102 includes a keyword trading unit 112. The keyword trading unit 112 configured to enable the users to search, buy or sell the keyword(s). The keyword trading unit 112 comprises a keyword searching logic 114 enabling the user to search for the availability of desired keyword(s) and retrieve the information associated with the keyword(s) and the market price of the keyword(s).

The keyword selling logic 116 of the keyword trading unit 112 is configured to enable the owners to sell the keyword(s) and also enable the owners to associate a price range for selling the keywords in the search network. The owner of the keyword(s) may also allow the user to initiate bidding of the keyword(s) by associating a minimum value to a maximum value of the price range.

The keyword trading unit 112 also includes a keyword buying logic 118 configured for enabling the users to buy the keyword(s). The user may be allowed to register with the system 102 by providing the preferences and selecting the desired keyword(s) using the keyword analytics logic 122 supported by the keyword trading unit 112. The keyword analytics logic 122 helps the user to analyze and forecast the search trends of keyword(s) in the search network. The user may be allowed to select the desired keyword(s) and add the selected keyword(s) to the cart and proceed for the payment. The user may use the earned assets for making the payment. After completing the successful transaction the keyword(s) are credited in the user wallet.

The keyword trading unit 112 also includes a wallet managing logic 120 configured for managing the trading activities of the user in the search network. The keyword trading unit 112 also includes wallet management logic 120 for managing the trading activities of the user accounts in the search network. The keyword trading unit 112 further includes an escrow service logic 122 configured to manage transactions between a buyer of the keyword(s) and the seller of the keyword(s). For example, if the user buys selected keyword(s) in the search network and completes the payment for purchasing the keyword(s), the seller of the keyword releases the purchased keyword(s) for crediting in the account of the user i.e., seller. The purchased keyword(s) are initially credited in the escrow account managed by the escrow service logic 122. The keyword(s) are then released to the user's account from the escrow account.

The keyword trading unit 112 also includes a keyword analytics logic 124. The keyword analytics logic 124 enables the user of the search network and the owner of the keyword(s) to view and identify the number of instances the keyword is used to conduct search in the search network in a predetermined time period ranging from hours-days-weeks-months-years.

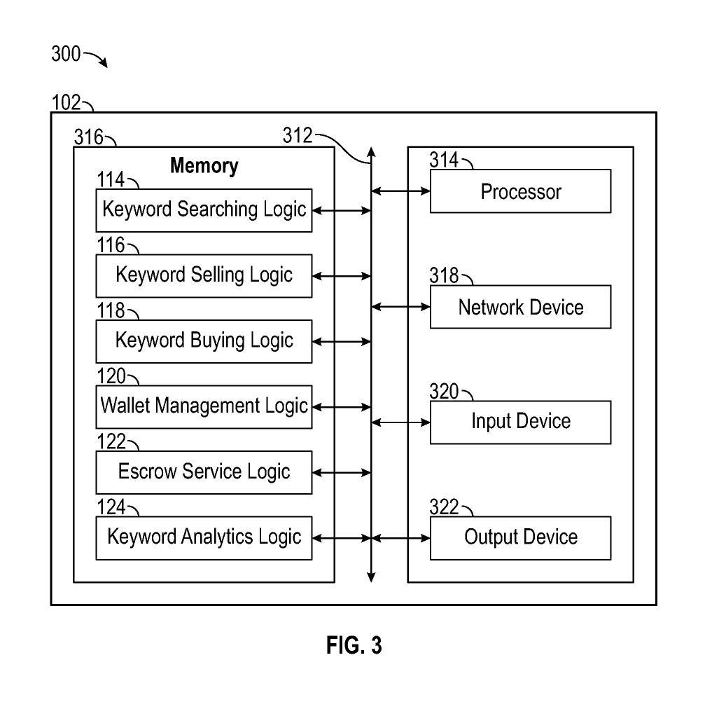

Referring to FIG. 3 is a diagram 300 depicting the system 102, according to an exemplary embodiment of the present disclosure. It should be noted, however, that embodiments are not limited to implementation on such computing devices, but may be implemented on any of a variety of different types of computing units within the scope of embodiments hereof. The system 102 is only one example of search and it is not intended to suggest any limitation as to the scope of use or functionality of the disclosure.

In some embodiments, the system 102 may include a bus 312, a processor 314, a memory 316, a network device 318, an input device 320, and an output device 322. The bus 312 may include a path that permits communication among the components of the system 102.

The memory 316 stores the keyword searching logic 114, the keyword selling logic 116, keyword buying logic 118 and the wallet management logic 120. The keyword searching logic 114, the keyword selling logic 116, keyword buying logic 118 and the wallet management logic 120 may be stored as software in memory 316.

The memory 316 may be any type of computer memory known in the art or future-developed for electronically storing data and/or logic, including volatile and non-volatile memory. In this regard, memory 316 can include random access memory (RAM), read-only memory (ROM), flash memory, any magnetic computer storage unit, including hard disks, floppy discs, or magnetic tapes, and optical discs.

The processor 314 comprises processing hardware for interpreting or executing tasks or instructions stored in the memory 316. Note that the processor 314 may be a microprocessor, a digital processor, or other type of circuitry configured to run and/or execute instructions.

The network device 318 may be any type of network unit (e.g., a modem) known in the art or future-developed for communicating over a network 110 (FIG. 1).

The input device 320 is any type of input unit known in the art or future-developed for receiving data. As an example, the input unit 320 may be a keyboard, a mouse, a touch screen, a serial port, a scanner, a camera, or a microphone.

The output device 322 may be any type of output unit known in the art or future-developed for displaying or outputting data. As an example, the output device 322 may be a liquid crystal display (LCD) or other type of video display unit, a speaker, or a printer.

Further note that, the system 102 components may be implemented by software, hardware, firmware or any combination thereof. In the exemplary system 102, depicted by FIG. 1 and FIG. 2, all the components are implemented by software and stored in the memory 316.

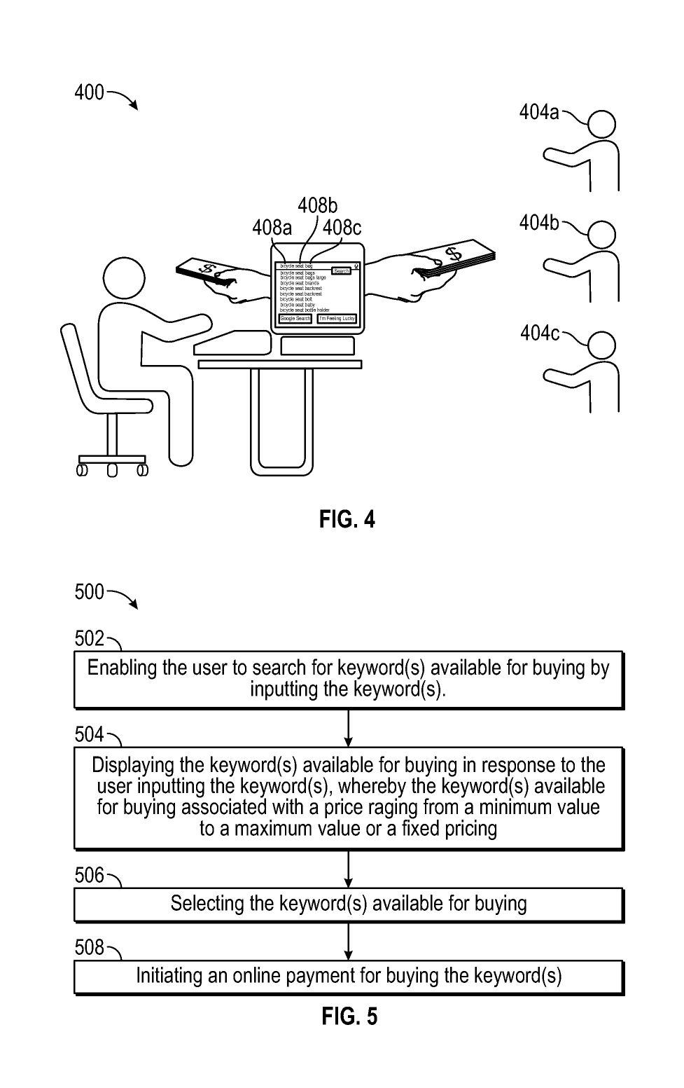

FIG. 4 is a use case diagram of a system for trading keyword(s), according to an exemplary embodiment of the present disclosure. The system comprises a computing device 402, keyword owners 404a, 404b and 404c, user 406. For example, consider the owner of the keyword 408a as 404a, the owner of the keyword 408b as 404b and the owner of the keyword 408c as 404c. The user 406 initiates a search in the computing device 402 by inputting the keywords 408a, 408b, and 408c. In response to conducting the search the user 406 earns assets and the earned assets are dynamically credited to the account of the user 406. Simultaneously, the accounts of the keyword owners 404a, 404b and 404c are also dynamically credited with the assets for using the keywords user 406 in the search network.

Referring to FIG. 5 is a flow diagram 500 depicting a method for buying keyword(s), according to an exemplary embodiment of the present disclosure. The method starts at step 502 by enabling the user to search for keyword(s) available for buying by inputting the keyword(s). The method continues to next step 504 by displaying the keyword(s) available for buying in response to the user inputting the keyword(s), whereby the keywords available for buying associated with a price raging from a minimum value to a maximum value or a fixed pricing. The method continues to next step 506 by selecting the keyword(s) available for buying. The method continues to next step 508 by initiating an online payment for buying the keyword(s).

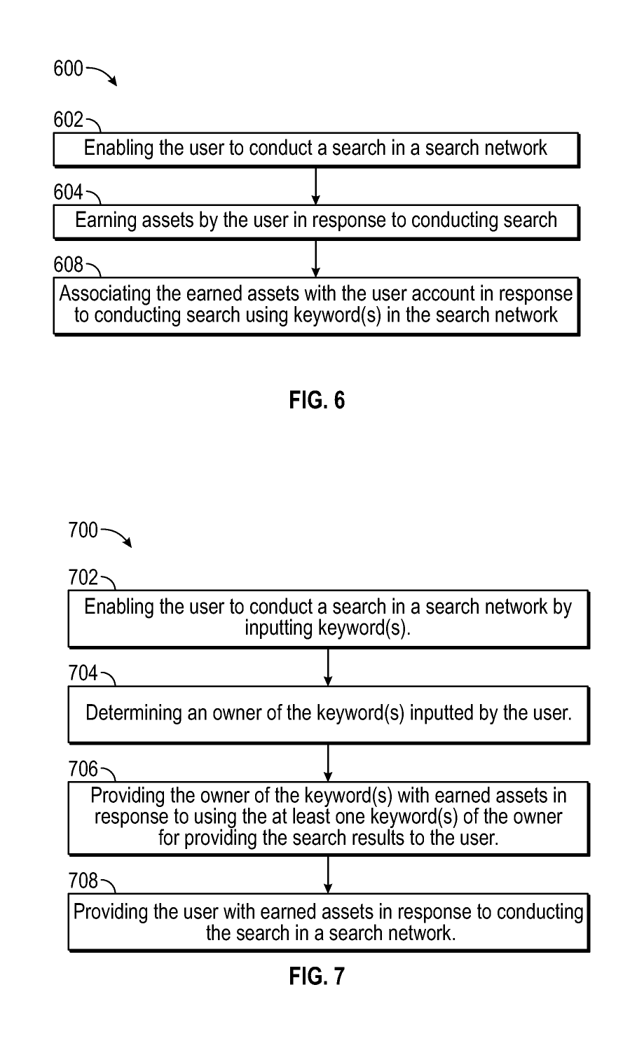

Referring to FIG. 6 is a flow diagram 600 depicting the method for earning assets by the user, according to an exemplary embodiment of the present disclosure. The method starts at step 602 by enabling the user to conduct a search in the search network. The method continues to next step 604 by earning assets by the user in response to conducting search. The method continues to next step 606 by associating the earned assets with the user account in response to conducting the search using the keyword(s) in the search network.

Referring to FIG. 7 is a flow diagram 700 depicting the method for earning assets by the user and the owner, according to an exemplary embodiment of the present disclosure. The method starts at step 702 by enabling the user to conduct a search in the search network by inputting the keyword(s). The method continues to next step 704 by determining an owner of the keyword(s) inputted by the user. The method continues to next step 706 by providing the owner of the keyword with earned assets in response to using the keyword(s) of the owner for providing the search results to the user. The method continues to next step 708 by providing the user with earned assets in response to conducting the search in the search network.

The claimed subject matter has been provided here with reference to one or more features or embodiments. Those skilled in the art will recognize and appreciate that, despite of the detailed nature of the exemplary embodiments provided here; changes and modifications may be applied to said embodiments without limiting or departing from the generally intended scope. These and various other adaptations and combinations of the embodiments provided here are within the scope of the disclosed subject matter as defined by the claims and their full set of equivalents.

1. A computer implemented method comprising:
enabling a user to search for at least one keyword available for buying by inputting the at least one keyword;
displaying the at least one keyword available for buying in response to the user inputting the at least one keyword, whereby the at least one keyword available for buying associated with at least one of: pricing raging from a minimum value to a maximum value; a fixed pricing;
selecting the at least one keyword available for buying; and
initiating an online payment for buying the at least one keyword.

2. The method of claim 1, comprising a step of enabling a user to earn assets for buying the at least one keyword.

3. The method of claim 2, wherein the user earns assets in response to conducting a search.

4. The method of claim 2, wherein the earned assets associated with a user account.

5. The method of claim 2, comprising a step of making a payment using the earned assets associated with a user account for initiating the online payment for buying the at least one keyword.

6. A computer implemented method comprising:
enabling a user to conduct a search in a search network;
earning assets by the user in response to conducting search; and
associating the earned assets with a user account in response to conducting the search using the at least one keyword in the search network.

7. The method of claim 6, wherein the step of trading the at least one keyword in the search network comprising at least one of: buying the at least one keyword; and selling the at least one keyword.

8. A computer implemented method comprising:
enabling a user to conduct a search in a search network by inputting at least one keyword;
determining an owner of the at least one keyword inputted by the user;
providing the owner of the keyword with earned assets in response to using the at least one keyword of the owner for providing the search results to the user; and
providing the user with earned assets in response to conducting the search in a search network.

9. A system comprising:
a search network comprising a keyword trading unit for:
displaying the at least one keyword available for buying in response to a user inputting the at least one keyword;
determining an owner of the at least one keyword inputted by the user;
dynamically crediting assets to an account of owner of the keyword in response to using the at least one keyword of the owner in the search network for providing the search results to the user; and
dynamically crediting assets the user account in response to conducting the search in a search network.

10. The system of claim 9, wherein the keyword trading unit comprising a keyword searching logic for enabling the user to conduct search and provide search results

11. The system of claim 10, wherein the keyword searching logic further enables the user to conduct search for buying the at least one keyword.

12. The system of claim 9, wherein the keyword trading unit comprising a keyword selling logic for enabling the owner to sell the at least one keyword in the search network.

13. The system of claim 12, wherein the keyword selling logic further enables the owner to associate a price range for selling the at least one keyword in the search network.

14. The system of claim 9, wherein the keyword trading unit comprising a keyword buying logic for enabling the user to buy the at least one keyword in the search network.

15. The system of claim 9, wherein the keyword trading unit comprising a wallet managing logic configured for managing the trading activities of the user in the search network.

16. The system of claim 9, wherein the keyword trading unit comprising an escrow service logic for providing escrow services for trading at least one keyword.

17. The system of claim 9, wherein the keyword trading unit comprising a keywords analytics logic for forecasting and analyzing trends of the value of the at least one keyword.

18. The system of claim 9, wherein the keyword(s) trading may be recorded in a block chain.

19. The system of claim 9 further comprising a data repository unit for enabling the user to trade the at least one keyword.
